(19) United States
(12) Patent Application Publication
(10) Pub. No.: US 2024/0378758 A1
(43) Pub. Date: Nov. 14, 2024

(54) METHOD FOR REDUCING DATA WITH REDUCED INFORMATION LOSS IN LIDAR SYSTEMS

(71) Applicant: Robert Bosch GmbH, Stuttgart (DE)

(72) Inventor: Mario Lietz, Vaihingen An Der Enz (DE)

(21) Appl. No.: 18/642,893

(22) Filed: Apr. 23, 2024

(30) Foreign Application Priority Data
May 11, 2023 (DE) 10 2023 204 346.7

(51) Int. Cl. G06T 9/00

(52) U.S. Cl. CPC G06T 9/00

(57) ABSTRACT

A method for reducing data with reduced information loss in LiDAR system including a transmitting unit and a receiving unit. In the method, in step a), all points of a point cloud to be compressed are compared for similarity to other points of the relevant point cloud. In step b), if a threshold value with regard to the similarity of a point to a further point is exceeded, the further point is not transmitted. For the not-transmitted point from the point cloud, additional information is generated in step c), which additional information allows reconstruction of the relevant not-transmitted point as a reconstructed point. In the case of sufficient reduction of data of the point cloud, the points are transmitted via a bandwidth-limited channel in step d). As soon as sufficient data reduction of the point cloud has been achieved, the data reduction is ended in step e).

### CROSS REFERENCE

The present application claims the benefit under 35 U.S.C. § 119 of German Patent Application No. DE 10 2023 204 346.7 filed on May 11, 2023, which is expressly incorporated herein by reference in its entirety.

### FIELD

The present invention relates to a method for reducing data with reduced information loss in LiDAR systems comprising a transmitting unit and a receiving unit. Furthermore, the present invention relates to the use of the method in a LiDAR system for reducing data with reduced information loss.

### BACKGROUND INFORMATION

German Patent Application No. DE 11 2018 004 878 T5 describes a system and a method for compressing and decompressing point clouds comprising a plurality of points with respectively associated spatial information and further attribute information. The system can, for example, comprise an encoder configured to generate a compressed point cloud in order to reduce costs and time associated with storing and transmitting large point cloud files.

German Patent Application No. DE 11 2020 004 139 T5 describes a method for creating maps in the area of autonomous driving. In order to reduce the bandwidth requirements and memory requirements of the system, the data from the map stream can be minimized or compressed. For example, LiDAR plane slicing or LiDAR point reduction can be performed.

German Patent Application No. DE 11 2020 001 131 T5 relates to LiDAR systems and associated methods using light detection and ranging technology. In this case, a successive refining technique can be used, which can be used to reduce the amount of data.

LiDAR systems detect their environment and, for the detected objects, in particular provide the radial distance with respect to the elevation and azimuth angles. The entirety of the detection is also referred to as a point cloud. Furthermore, further data are often provided, such as reflectivity, pulse energy, or background light for the points (reflections). In the case of modern LiDAR systems with a large detection range and high resolution, a bandwidth of 1 Gbit/s is generally not sufficient to transmit all detected points in all circumstances.

The limited bandwidth makes it necessary to limit the maximum data rate. This is achieved by limiting the permissible detections per spatial direction (angle). Thus, only two or three points per pixel are usually transmitted. The reduction takes place per spatial direction (pixel) and is based on distance criteria or pulse energy criteria and, alternatively, a combination of several criteria. Depending on the scenario, this can lead to significant information losses. For example, in rain or when detecting vegetation, a great many reflections are generated so that the data reduction has the result that reflections for objects relevant in the application are not transmitted, for example small, poorly reflecting objects that could be missing in the transmission of the point cloud. In this case, the actual information content is not taken into account for the transmission. This is in particular a technical challenge, especially in the case of precipitation.

### SUMMARY

According to the present invention, a method for reducing data with reduced information loss in LiDAR systems comprising a transmitting unit and a receiving unit is provided. According to an example embodiment of the present invention, the method includes the following method steps:
a) all points of a point cloud to be compressed are compared for similarity to other points of the relevant point cloud;
b) if a threshold value with regard to the similarity of a point to a further point from the point cloud is exceeded, the further point is not transmitted;
c) for the not-transmitted point from the point cloud, additional information is generated, which additional information allows reconstruction of the relevant not-transmitted point as a reconstructed point;
d) in the case of sufficient reduction of data of the point cloud, the points are transmitted via a bandwidth-limited channel; and
e) the data reduction is ended after accomplishing method step d).

The method provided according to an the present invention can achieve a data reduction without information loss with respect to a point cloud recorded by a LiDAR system, so that all relevant objects are retained, cannot disappear due to the data reduction, and can be used for a downstream perception.

In an advantageous embodiment of the method provided according to the present invention, according to method step a), the reduction of the data of the point cloud takes place sequentially such that portions of the point cloud to be compressed are compressed one after the other.

In an advantageous embodiment of the method provided according to the present invention, either individual columns or segments of columns or individual rows or segments of rows of the point cloud to be compressed can be compressed one after the other in time for this purpose.

In the method provided according to an example embodiment of the present invention, according to method steps a) and/or b), a similarity determination takes place by pairwise comparison of neighboring points within the point cloud.

In the method provided according to an example embodiment of the present invention, prioritization within the scanning range of the LiDAR system can be achieved by the order of the processing.

In an advantageous design variant of the method provided according to the present invention, a metric, in particular a distance dimension, can be used to transmit the points with maximum information gain of the point cloud to be compressed.

In the method provided according to an example embodiment of the present invention, when determining the similarity according to method steps a) and b), the radial distance of the points can, for example, be used as a comparison criterion for ascertaining neighboring points.

In the method provided according to an example embodiment of the present invention, there is the possibility, according to method steps a) and/or b), of using the radial distance of the points and the echo intensity of the points as comparison criteria of neighboring points.

In a further modification of the method provided according to the present invention, according to method step a), the echo intensity of the points can be used as a comparison criterion for ascertaining neighboring points.

In a development of the method provided according to the present invention, according to method steps a) and/or b), the background intensity of the points is used as a comparison criterion for ascertaining neighboring points.

In an advantageous modification of the method provided according to the present invention, according to method steps a) and b), the radial distance of the points, the echo intensity of the points, and the background intensity of the points can be used as comparison criteria for ascertaining neighboring points.

In the method provided according to the present invention, there is also the possibility, according to method steps a) and/or b), of using the echo intensity of the points and the background intensity of the points as comparison criteria for ascertaining neighboring points.

Finally, the present invention relates to the use of the method in a LiDAR system for reducing data with reduced information loss.

By means of the solution provided according to the present invention, data of a point cloud that a LiDAR system receives can be reduced, in particular compressed. In this case, the fact is utilized that larger objects usually generate several reflections with similar properties, for example radial distance and pulse energy. The reflections with different properties are preferably transmitted here and, when compressing the data, the reflections that have the greatest similarity to other reflections in the point cloud are removed first from the data transmission. The actual information content is thus also taken into account in the data reduction.

Furthermore, in the method provided according to the present invention, in the case of a greatly reduced amount of data, the points previously removed from the transmission due to the limited bandwidth can be reconstructed again by means of transmitted additional information when decoding the data on the receiver side of the LiDAR system, so that an image very close to reality can be achieved on the receiving unit of the LiDAR system.

Currently used methods for reducing the amount of data generally apply prioritization rules. It follows therefrom that, for example, echoes with minimum echo intensity are discarded according to the prioritization rules. However, this constitutes a safety-critical circumstance inherent in the system, because in particular small, poorly visible objects have low intensities. This safety-critical disadvantage is avoided by the solution proposed according to the present invention. In the solution proposed according to the present invention, small important details of a scene can in particular be retained.

### BRIEF DESCRIPTION OF THE DRAWINGS

The present invention is described in greater detail below with reference to the figures.

FIG. 1 shows a point cloud with transmitted and not-transmitted detections or points.

FIG. 2 shows the representation of reconstructed points due to a transmission of a reconstruction flag.

FIG. 3 shows a flowchart for the data reduction according to a method according to an example embodiment of the present invention.

### DETAILED DESCRIPTION OF EXAMPLE EMBODIMENTS

In the following description of the embodiments of the present invention, identical or similar elements are denoted by identical reference signs, wherein a repeated description of these elements is omitted in individual cases. The figures show the subject matter of the present invention only schematically.

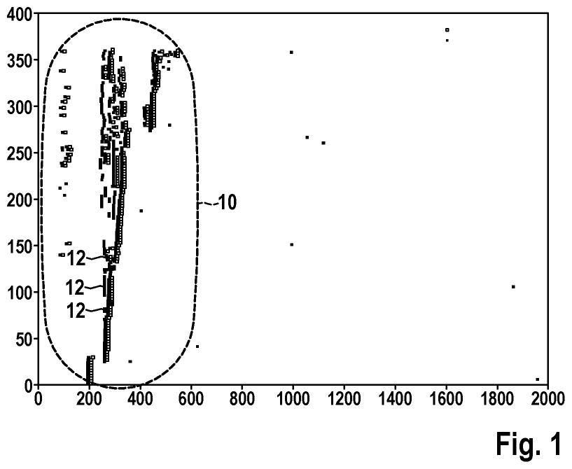

FIG. 1 shows a point cloud 10 with transmitted detections, i.e., points 12, and not-transmitted detections, i.e., not-transmitted points 12, of the point cloud 10 to be compressed.

FIG. 1 schematically shows real data, for example a scenario of a forest with a great many detections, i.e., points 12, within a point cloud 10. With currently applied data reduction mechanisms, real data from objects cannot be transmitted and cannot be processed further; i.e., the information content inherent in the not-transmitted objects would be lost, as a result of which, in the worst case scenario, objects are not recognized or are recognized too late by a perception. Current data reduction mechanisms use a prioritization hierarchy so that objects cannot be mapped in the point cloud 10 and therefore cannot be available for further processing of the scene.

The data reduction is independent of the transmitting unit and alternatively takes place in the receiving unit or downstream thereof in the data processing prior to performing the transmission.

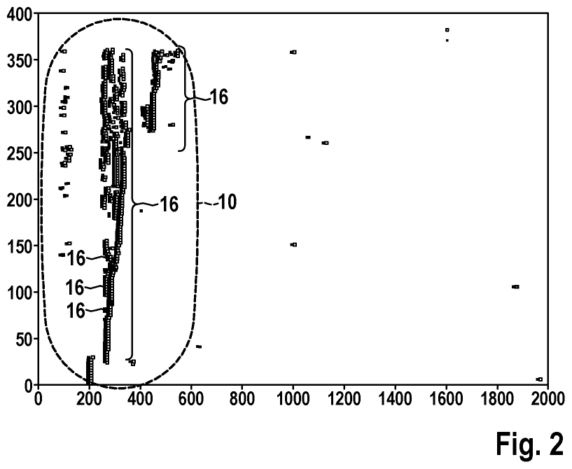

The representation according to FIG. 2 shows a sectional view of a detection. Here, reconstructed points 16 of the point cloud 10 are shown in their entirety.

The comparison of FIGS. 1 and 2 has the result that the reconstructed points 16 have been reconstructed exactly at the same location as the points 12, for example by transmission of a reconstruction flag. In the representation according to FIG. 2, exactly all echoes are present, even those of compressed points 12 with the same radial distance. This means that the scene according to FIG. 2 is represented nearly completely because the reconstructed points 16 complete and substantially completely represent the scene. The point cloud 10 shown in FIG. 2 is thus composed of transmitted points 12 and reconstructed points 16, which have been restored due to a transmission of the reconstruction flags (additional information 44) and which render the detected scene substantially completely.

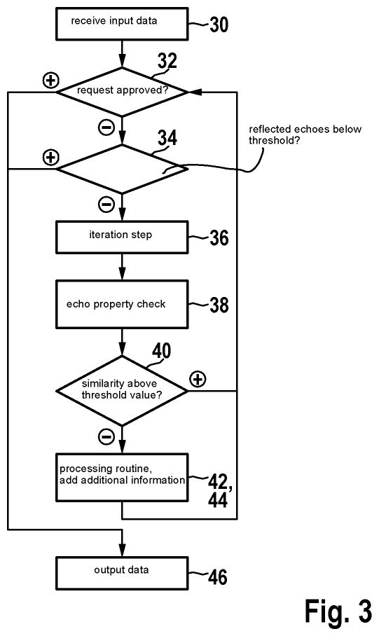

FIG. 3 schematically shows a possible sequence of the method proposed according to the present invention. Starting from the input data 30 received by the receiving unit of a LiDAR system, a request 32 for processing all points or detections 12 of the point cloud 10 is subsequently made. If this request 32 is approved, branching to output data 46 takes place directly. If it is denied, an echo classification 34 as to whether the reflected echoes of the pulses emitted by the transmitting unit are below a threshold takes place after the request 32. If this is true, i.e., if yes, branching to the output data 46 takes place, which means that the relevant echo represents a point 12 that is transmitted.

If, on the other hand, it is determined as part of the echo classification 34 that the echo is not below a particular threshold, an iteration step 36 follows to the next detection 12 of the point cloud 10 to be compressed.

This is followed by an echo and echo property check 38 between neighboring points 12 or the detection thereof. As part of this comparison, a similarity determination 40 takes place as to whether the compared echoes are below a threshold. If this is true, branching back to the request 32 for processing all points 12 of the point cloud 10 takes place.

If a similarity of compared echoes above a threshold value is detected as part of the similarity determination 40, additional information 44 is added as part of a processing routine 42 of the relevant reflection or the relevant echo, which additional information later makes it possible to reconstruct this not-transmitted point or the not-transmitted detection 12 of the scene, i.e., to complete the scene, in the receiving unit.

By means of the method proposed according to the present invention, all points 12 of the point cloud 10 to be compressed are compared for similarity to further points 12 within the point cloud 10. If a previously defined threshold value for the similarity between two points 12 is exceeded, the relevant point 12 is not provided for the transmission and, within the processing routine 42, is provided with additional information 44, which enables its reconstruction. If sufficient reduction of the data of the point cloud 10 has been achieved at the end of the data compression, transmission of these data can take place via a bandwidth-limited channel. The data reduction has thus achieved its purpose.

There is the possibility of carrying out the method proposed according to the present invention in a sequential order. In this case, portions of the entire point cloud 10 to be compressed are compressed one after the other in order, for example, to optimize the latency of the data transmission. As part of this sequential processing, individual columns or segments of columns and/or individual rows or segments of rows can be processed.

The similarity determination 40 or the method steps a) and b) can, for example, take place by a pairwise comparison of neighboring points 12 in order to significantly reduce the computational effort in the compression. In this case, prioritization within the scanning range of the LiDAR system can be achieved by the order of the processing. As an alternative to the order of the processing, a metric, in particular a distance dimension, can also be used to transmit the points 12 that promise the greatest information gain.

As part of the, for example pairwise, comparison of neighboring points 12 within the point cloud 10 to be compressed, it is, for example, possible to use, as comparison criteria, the radial distance of the neighboring points 12 or the radial distance of the points and the echo intensity of the points or also the radial distance of the points, the echo intensity of the points, and the background intensity of the points as comparison criteria. Various combinations of these comparison criteria are likewise possible in order to compress the point cloud 10.

The present invention is not limited to the exemplary embodiments described here and the aspects highlighted therein. Rather, a plurality of modifications is possible, which lie within the abilities of a person skilled in the art.

What is claimed is:

1. A method for reducing data with reduced information loss in a LiDAR system including a transmitting unit and a receiving unit, the method comprising the following steps:
a) comparing all points of a point cloud to be compressed for similarity to other points of the point cloud;
b) based on a threshold value with regard to the similarity of a point from the point cloud to a further point from the point cloud being exceeded, not transmitting the further point;
c) for the not-transmitted point from the point cloud, generating additional information, the additional information allowing reconstruction of the not-transmitted point as a reconstructed point;
d) based on a sufficient reduction of data of the point cloud, transmitting remaining points of the point cloud via a bandwidth-limited channel; and
e) ending the data reduction after accomplishing d).

2. The method according to claim 1, wherein in the method step a), the reduction of the data takes place sequentially such that portions of the point cloud to be compressed are compressed one after the other.

3. The method according to claim 2, wherein: (i) individual columns of the point cloud, or (ii) segments of columns of the cloud, or (iii) individual rows of the point cloud, or (iv) segments of rows of the point cloud, are compressed one after the other in time.

4. The method according to claim 1, wherein, in the method step a) and/or b), a similarity determination takes place by a pairwise comparison of neighboring points.

5. The method according to claim 4, wherein prioritization within a scanning range of the LiDAR system is achieved by an order of processing.

6. The method according to claim 4, wherein a metric including a distance dimension, is used to transmit the points with maximum information gain of the point cloud to be compressed.

7. The method according to claim 3, wherein in the method steps a) and/or b), a radial distance of the points is used as a comparison criterion for ascertaining neighboring points.

8. The method according to claim 3, wherein in the method steps a) and/or b), a radial distance of the points and an echo intensity of the points are used as comparison criteria for ascertaining neighboring points.

9. The method according to claim 3, wherein in the method step a), an echo intensity of the points is used as a comparison criterion for ascertaining neighboring points.

10. The method according to claim 3, wherein in method steps a) and/or b), a background intensity of the points is used as a comparison criterion for ascertaining neighboring points.

11. The method according to claim 3, wherein, in the method steps a) and/or b), a radial distance of the points, an echo intensity of the points, and a background intensity of the points are used as comparison criteria for ascertaining neighboring points.

12. The method according to claim 3, wherein, according to method steps a) and/or b), an echo intensity of the points and a background intensity of the points are used as comparison criteria for ascertaining neighboring points.

13. The method according to claim 1, wherein the method is used in the LiDAR system for reducing data with reduced information loss.
